(19) United States
(12) Patent Application Publication
(10) Pub. No.: US 2009/0139649 A1
(43) Pub. Date: Jun. 4, 2009

(54) Device And Method For Patterning A Workpiece

(76) Inventors: Ludwig Albrecht, Dornstetten-Aach (DE); Karl Frey, Schopfloch (DE); Johannes Schmid, Starzach/Wachendorf (DE)

Correspondence Address: FITCH EVEN TABIN AND FLANNERY, 120 SOUTH LASALLE STREET, SUITE 1600, CHICAGO, IL, 60603-3406, US

(21) Appl. No.: 12/324,181

(22) Filed: Nov. 26, 2008

(30) Foreign Application Priority Data
Nov. 30, 2007 (EP) 07 023 301.0

(51) Int. Cl. B32B 38/14

(52) U.S. Cl. 156/277; 156/387

(57) ABSTRACT

The invention relates to a device (1) for patterning a workpiece (2) consisting preferably at least partly of wood, wood materials, plastics material or the like, comprising a first web provision unit (10; 50) for providing a first web-shaped material (12; 52) preferably in such a way that said material can be applied to a surface (2′) of the workpiece (2), a first printing unit (20; 22) for imprinting the first web-shaped material (12; 52), and a press-on means (30) and/or roll-up means (40) for pressing on and/or rolling up at least the first web-shaped material (12; 52). The device according to the invention is characterised in that it further has at least a second web provision unit (50; 10) for providing at least a second web-shaped material (52; 12) in such a way that the second web-shaped material (52; 12) can be connected to the first web-shaped material (12; 52).

### TECHNICAL FIELD

The invention relates to a device for patterning a workpiece consisting preferably at least partly of wood, wood materials, plastics material or the like, according to the preamble of claim 1 and to a method for patterning a workpiece using a device of this type.

### PRIOR ART

In the field of the patterning of workpieces, such as are required for example for the furniture or component industry, in addition to direct patterning methods, methods have also become established in which a sheet is imprinted and subsequently applied to the workpiece surface.

Thus, for example, DE 20 2005 021 236 U1 discloses a device in which a web-shaped material is imprinted by a printing means and then glued continuously onto a surface of a workpiece. Although this technology has proven successful in practice, certain difficulties have arisen. Thus, in the case of external imprinting of the web-shaped material, after the gluing-on a coat of lacquer has to be applied to protect the printed image. This complicates the procedure and entails the risk of soiling of the workpieces.

This can be counteracted by internal imprinting of the web-shaped material. However, this requires the use of a transparent web-shaped material imprinted over the entire area, as otherwise the printed image is not visible or the underlying structure of the workpiece shows through. This makes the manufacturing process more costly and less variable.

### DESCRIPTION OF THE INVENTION

It is therefore the object of the present invention to provide a device and a method of the type mentioned at the outset that allow, in a simple manufacturing process, variable and high-quality patterning of the workpieces.

According to the invention, this object is achieved by a device according to claim 1 and a method according to claim 12. Particularly preferred embodiments of the invention are disclosed in the dependent claims.

Against this background, the invention provides for a device of the same type further to have at least a second web provision unit for providing at least a second web-shaped material in such a way that the second web-shaped material can be connected to the first web-shaped material.

In this manner, it is possible, by way of a combination of the plurality of web-shaped materials, to achieve a broad range of combination effects or to assign to the web-shaped materials different tasks which can be superimposed on and combined with one another. Thus, for example, a web-shaped material which is additionally provided in accordance with the invention can perform a protective function for the web(s) lying therebelow and at the same time an (internal) pattern function, wherein the pattern of the various webs can advantageously be superimposed and added to form an overall pattern. As a result, any reworking costs are dispensed with, and novel optical and if appropriate also haptic effects can be achieved. Overall, a variable and high-quality appearance of the workpieces is thus obtained with simple manufacture.

In this case, the present invention is equally applicable to two main target directions. In a first main target direction, the web-shaped materials are after (or if appropriate even before or during) the imprinting pressed onto the respective workpiece using a press-on means. This delays the decision concerning the respective pattern of the workpieces to an extremely late point in time, thus broadening the diversity of variants. In a second main target direction, the web-shaped materials are after the imprinting rolled on using a roll-on means in order then to be applied to desired workpieces at any desired point in time and at any desired location. This provides a broader range of use of the technology according to the invention and fewer, and accordingly higher-quality, printing means can be used.

The term “web-shaped material” refers in the context of the present invention in the first place to materials which are suitable for the planar coating of the surface of workpieces. In this case, the shape of the web-shaped materials is not particularly restricted. On the contrary, they can also be narrow webs (for example strips) or web portions (for example short, precut webs).

In addition, the web-shaped materials can be transparent, semitransparent or opaque and in this case be provided, if appropriate in advance, with a pattern or a primary colour. However, in order to achieve, in particular in non-patterned starting materials, an even greater degree of variability and optical effects, a development of the invention provides for the device further to have at least a second printing unit for imprinting the second or a further web-shaped material.

According to a development of the device according to the invention, provision is additionally made for the device further to have a conveying means using which a relative movement between the workpieces and the first web provision unit can be generated. This provides a prompt and trouble-free (for example crease-free) operation of the device according to the invention, wherein with regard to high productivity of the device according to the invention a continuous conveying means has proven advantageous, such as for example a conveying device comprising a revolving endless conveying element (belt, chain, magnetic chain, etc.), an air cushion conveying device (optionally comprising a belt) or else combinations thereof.

Within the scope of the invention, the web-shaped materials can be imprinted on any desired side, if appropriate also in each case on both sides. In this case, it is provided according to a development of the invention that of the printing units at least the printing unit located at the end in a direction of conveyance of the workpieces is configured to imprint a side of the respective web-shaped material that faces the workpiece. This means that the external web-shaped material (facing away from the workpiece) is imprinted on its inside, so that no further measures are required to protect the patterning of the web-shaped materials. This gives rise not only to a simple procedure with low reworking costs, but rather also to a low risk of soiling for the workpieces.

In addition, according to a development of the invention, provision is made for at least one printing unit to be configured to imprint a side of the respective web-shaped material that faces away from the workpiece. This provides, in particular in the case of web-shaped materials located further inward (facing the workpiece), particular optical and if appropriate also haptic effects which are then visible for example through a transparent or semitransparent web-shaped material lying thereabove and are if appropriate superimposed with the pattern of this web-shaped material lying thereabove.

Against this background, according to a development of the invention, it is provided that of the web provision units at least the web provision unit located at the end in a direction of conveyance of the workpieces provides a web-shaped material which is transparent or semitransparent at least in certain portions. Particular optical and also three-dimensional effects can, as mentioned hereinbefore, be achieved in this way, in particular by way of a superimposition of the patterns of a plurality of web-shaped materials.

Alternatively or additionally, according to a development of the invention, provision is made for at least one web provision unit to provide a web-shaped material which is opaque, preferably patterned, at least in certain portions.

The provision of an opaque, web-shaped material allows the imprinting costs in the device according to the invention to be reduced. Thus, the opaque, web-shaped material can for example ensure that the underlying material of the workpiece does not show through the web-shaped material, and at the same time the opaque, web-shaped material can serve as the basis for the application of a desired pattern which is formed for example against the background of the opaque, web-shaped material. In this case, it is equally possible for the web-shaped material itself already to have a pattern and no longer to be able and to have to be individually imprinted or to be able and to have to be individually imprinted only to a slight extent. This provides, with still very high variability and quality, an economical and prompt manufacturing method.

In addition, according to a development of the invention, provision is made for the device further to have at least one press-together unit for pressing together at least two web-shaped materials. This provides, optionally in combination with separate adhesives which can be activated or applied, a secure bond of the web-shaped materials to one another; this contributes not only to good durability, but rather also to an attractive appearance of the manufactured workpieces.

Against this background, according to a development of the invention, provision is made for the device further to have at least one adhesive application unit and/or at least one adhesive activation unit.

Furthermore, according to a development of the invention, provision is made for the device further to have, for at least one web-shaped material to be imprinted, at least one pretreatment module selected from the group consisting of a precleaning module, a degreasing module, a module for improving the adhesion and wetting properties, a module for reducing the electrostatic charge and an embossing module. This ensures high quality and durability of the printed image applied to the respective web-shaped materials; this makes a significant contribution to the quality, the appearance and to the durability of the manufactured workpiece.

In particular in the case of the above-described, second main target direction, which has a take-up means, according to a development of the invention, provision is made for the device further to have a division means for dividing at least one web-shaped material in the longitudinal direction thereof. As a result, not only can the device according to the invention perform a plurality of functions simultaneously, but rather it can also carry out these functions in an optimum manner in such a way that they are coordinated with one another. This means for example that the device according to the invention not only patterns the respective web-shaped materials, but rather also divides said materials, in view of and in precise coordination with the applied patterning, into corresponding strips, partial webs or the like. This provides not only a prompt and efficient operation, but rather also a high-quality and an attractive appearance of the web-shaped materials provided for patterning workpieces.

A particularly advantageous method for patterning a workpiece using the device according to the invention is defined in claim 12. This method allows in particular workpieces, such as are used in the field of the furniture and kitchen industry, to be patterned promptly, in a broad range of variants and with high quality. In this case, it is particularly preferred for at least one of the web-shaped materials pressed onto the surface of the workpiece to be machined in the edge region thereof, thus preferably generating a radius or a chamfer on the web-shaped material. As will become even clearer from the following detailed description of preferred embodiments, this greatly simplifies the patterning of workpieces in the edge region, as—in contrast to the prior art—even in the case of edges having a radius or chamfer, it is necessary to imprint no longer curved surfaces, but rather merely the generally flat surfaces of the web-shaped materials.

### BRIEF DESCRIPTION OF THE DRAWINGS

FIG. 1 is a schematic plan view of a device for patterning workpieces according to a first embodiment of the present invention;

FIG. 2 is a schematic plan view of a device for patterning workpieces according to a second embodiment of the present invention;

FIG. 3 is a schematic plan view of a device for patterning workpieces according to a third embodiment of the present invention;

FIG. 4 is a schematic plan view of a device for patterning workpieces according to a fourth embodiment of the present invention;

FIG. 5 is a schematic partial plan view of a workpiece manufactured by means of the device or the method according to the present invention;

FIG. 6 is a schematic plan view of a device for patterning workpieces according to a fifth embodiment of the present invention; and

FIG. 7 is a schematic plan view of a device for patterning workpieces according to a sixth embodiment of the present invention.

### DETAILED DESCRIPTION OF PREFERRED EMBODIMENTS

Preferred embodiments of the present invention will be described hereinafter in detail with reference to the accompanying drawings.

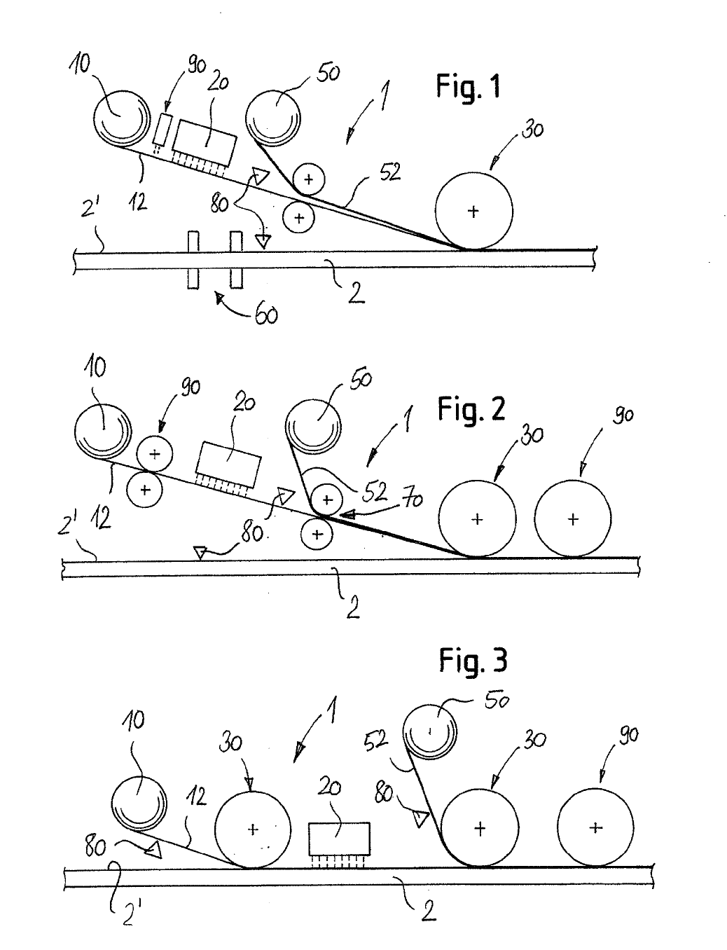

FIG. 1 is a schematic plan view of a device 1 for patterning a workpiece 2 according to a first embodiment of the present invention. The device 1 serves in the present embodiment to pattern a workpiece 2 consisting at least partly of wood, wood materials, plastics material or the like. Workpieces of this type are used widely for example in the furniture and component industry, wherein the workpieces can if appropriate also be lightweight building boards having a light core layer which is provided between cover layers and can be made for example of paper or another suitable lightweight material. However, it should in any case be noted that the present invention is not limited to the patterning of a specific type of workpiece.

The device 1 shown in FIG. 1 has firstly a conveying means 60 for conveying the respective workpieces 2 in a direction of passage (from left to right in FIG. 1), which conveying means is in the form of a roll conveyor in the present embodiment. However, as stated hereinbefore, the conveying means 60 can also be embodied in a broad range of manners. In this case, it is equally possible for the conveying means 60 to convey not (only) the respective workpiece 2, but rather one or more other components of the device 1 in relation to the respective workpiece 2.

Furthermore, the device 1 has in the present embodiment two web provision units 10, 50 for providing a first and second web-shaped material 12, 52 respectively in such a way that said material can be applied to a surface 2′ of the respective workpiece 2. In this case, the web provision units 10, 50 are in the present embodiment in the form of coils onto which the respective web-shaped material 12, 52 is wound.

The respective web-shaped material 12, 52, etc. can within the scope of the present invention be configured in a broad range of manners and for example be formed by a plastics material sheet, a paper web, a metal film, a veneer web and many further materials, wherein different web-shaped materials 12, 52 can also be combined with one another on a workpiece. In this case, it is particularly preferred for at least the web provision unit 50 located at the end in the direction of conveyance of the conveying device 60 to provide a semitransparent or if appropriate also transparent, web-shaped material 52.

Conversely, it is preferable for the web-shaped material 12 provided by the web provision unit 10 to be opaque and preferably patterned at least in certain portions, for example with a uniform primary colour, a wood pattern or any other desired pattern. However, in this case too, it should be noted that the present invention is not limited to a specific configuration of web-shaped materials.

Furthermore, the device 1 comprises in the present embodiment a first printing unit for imprinting the first web-shaped material 12. The first printing unit (and any further printing units) can for example be an inkjet printing unit, wherein other printing technologies can also be used, such as for example laser printing, thermal printing, etc.

Arranged upstream of the first printing unit 20 is in the present embodiment a treatment module 90 which is configured optimally to prepare the web-shaped material 12 to be imprinted, depending on its state and environmental conditions, for the subsequent printing process. For this purpose, the treatment module 90 can be formed by one or more modules selected from the group consisting of a precleaning module, a degreasing module, a module for improving the adhesion and wetting properties, a module for reducing the electrostatic charge and an embossing module. Examples of the configuration of modules of this type can be inferred for example from EP 1839883.

Furthermore, the device according to the invention comprises two adhesive application units 80 which are configured to apply a suitable adhesive to a surface of the web-shaped material 12 or the surface 2′ of the respective workpiece. In this case, the location of the respective application of adhesive can be varied widely; for example, instead of the first web-shaped material 12, alternatively or additionally the second web-shaped material 12 can also be provided with adhesive. In addition, it is also possible to provide, instead of an adhesive application unit, an adhesive activation unit which is configured to activate, for example by means of heat or the like, an adhesive already provided on the respective web-shaped material 12, 52 or the workpiece 2. Furthermore, the device 1 shown in FIG. 1 has a press-on means 30 in the form of at least one press-on roll for pressing the web-shaped materials 12, 52 onto the surface 2′ of the respective web-shaped material 2. In this case, the two web-shaped materials 12, 52 are also securely connected to each other, thus providing overall a durable and visually attractive workpiece.

In the present embodiment, the device 1 according to the invention is operated for example as follows. Workpieces 2 to be patterned are conveyed on the conveying means 60, while at the same time the web-shaped materials 12, 52 are provided by the web provision units 10, 50. In this case, the web-shaped material 12 is first pretreated on its side facing away from the workpiece 2 by the pretreatment module 90 and subsequently imprinted with a desired pattern by the printing means 20. Then, the web-shaped material 12 is, like the surface 2′ of the workpiece 2, provided with adhesive using the adhesive application units 80 until finally the press-on roll 30 presses the two web-shaped materials 12, 52 onto the surface 2′ of the workpiece 2. In this case, the two web-shaped materials 12, 52 are also joined together, thus providing a fully patterned workpiece. Although the workpiece manufactured in this way is already fully sealed and ready for use, it is within the scope of the present invention also possible to carry out further finishing steps on the workpiece, for example to apply a coat of lacquer to the web-shaped materials 12, 52, etc.

FIG. 2 is a schematic plan view of a second preferred embodiment of the device 1 according to the invention. This device corresponds in principle to the device 1 shown in FIG. 1 and discussed hereinbefore, so that only the special features differing therefrom of the device shown in FIG. 2 will be discussed hereinafter.

The device 1 shown in FIG. 2 is distinguished firstly by the fact that the pretreatment module 90 provides in the present embodiment two embossing rollers which impart a desired pattern or relief to the web-shaped material 12 upstream of the printing unit 20. Furthermore, provision is made in this embodiment for the device 1 further to have a press-together unit 70 for pressing the two web-shaped materials 12, 52 together. This allows the web-shaped materials 12, 52 to be pressed onto the surface 2′ of the workpiece 2 in the region of the press-on roll 30 even more precisely and in an even more crease-free manner.

Furthermore, the device 1 shown in FIG. 2 also has an additional embossing roll 90 which is provided downstream of the press-on roll 30 and can be used to apply a further embossed relief which in this case is also provided in the web-shaped material 52 and is superimposed with the relief already present in the web-shaped material 12, allowing particular optical effects to be achieved.

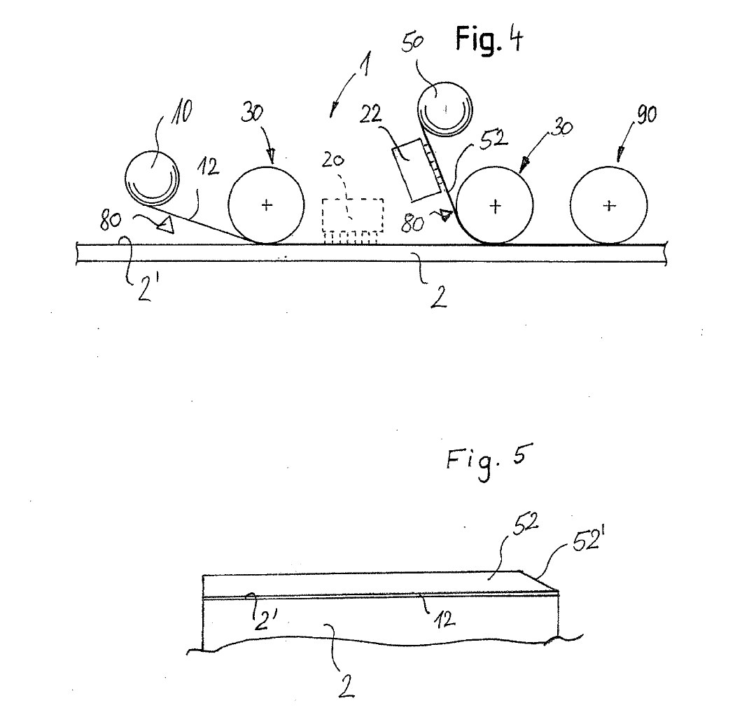

FIG. 3 is a schematic plan view of a third preferred embodiment of the device 1 according to the invention. The components of the device 1 shown in FIG. 3 correspond in principle to those of the above-discussed FIGS. 1 and 2, although said components are arranged differently in the present embodiment. In particular, the device 1 has in the embodiment shown in FIG. 3 two press-on rolls 30, and the printing device 20 is provided in the region between the press-on rolls 30. As a result, the web-shaped material 12 is imprinted only once it has been pressed onto the surface 2′ of the workpiece 2, producing a particularly precisely defined relative relationship between the web-shaped material 12 to be imprinted and the printing means 20, with corresponding advantages for the quality of the printed image.

FIG. 4 is a schematic plan view of a fourth preferred embodiment of the present invention. This embodiment corresponds again in principle to the embodiment shown in FIG. 3, but is nevertheless distinguished by the fact that there is provided, alternatively or additionally to the printing unit 20, a second printing unit 22 which imprints the side of the web-shaped material 52 that faces the workpiece 2. This allows particular optical effects to be achieved, in particular in combination with the first printing unit 20; in this case, it should be noted that the use of two or more printing units is possible in all relevant embodiments and can be desirable for achieving particular optical effects.

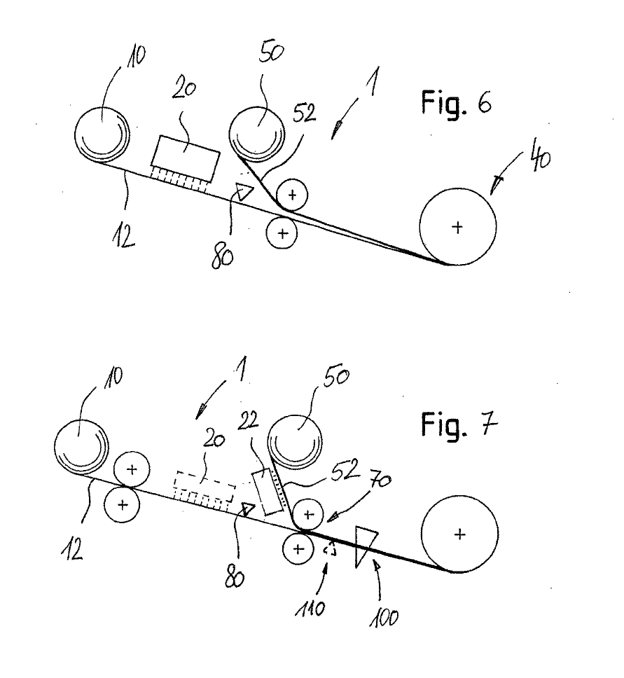

The operation of the second, third and fourth embodiment discussed hereinbefore of the device according to the invention corresponds in principle to the above-discussed, i.e. the first, embodiment. In all these embodiments, an additional optical and qualitative advantage can be achieved by subsequent machining, which will be described with reference to FIG. 5 which is a schematic partial plan view of a workpiece manufactured by means of the device or the method according to the present invention. As may be seen in FIG. 5, the workpiece 2 has in the region of its surface 2′ two web-shaped materials 12, 52. In this case, at least one of these webs has in the region of the common contact face a pattern applied in accordance with the invention. Subsequently, the workpiece was machined in the edge region thereof, for example in a material-removing manner or else otherwise, such as for example by means of a laser, as a result of which in the present embodiment a chamfer 52′ is generated on the web-shaped material 52. This allows, in particular if the web-shaped material 52 is a transparent or semitransparent material, a workpiece 2 provided with a chamfer or a different transition region to be provided without having to imprint curved or bevelled faces of the workpiece. This provides not only greatly simplified manufacture of the workpiece according to the invention, but rather also a greatly improved appearance and a high-quality feel of the workpiece.

FIG. 6 is a schematic plan view of a device 1 as a fifth preferred embodiment of the present invention. This embodiment differs from the embodiments shown in FIG. 1 to FIG. 4 in that, instead of the press-on means 30, a roll-up means 40 is provided for rolling up the web-shaped materials 12, 52. In this design, it is therefore not necessary to attach the web-shaped material 12, 52 to a workpiece immediately after the provision thereof by the provision units 10, 50 and the imprinting by the printing unit 20. On the contrary, the unit formed by the web-shaped materials 12, 52 can first be rolled up using the roll-up means 40 in order then to be applied to a workpiece at any desired later point in time. In this case, the rolled-up, web-shaped material can be applied to a workpiece in a conventional manner, or can for example be inserted into the web provision units 10 of the embodiments described in FIGS. 1 to 4 in order then to be supplied to the process according to the invention. Not only does this increase the flexibility of production, but rather particular optical effects can also be achieved, without for example complicating the design of the devices shown in FIG. 1 to FIG. 4.

FIG. 7 is a schematic plan view of a sixth preferred embodiment of the present invention. This embodiment differs from the embodiment shown in FIG. 6 in the first place in that, alternatively or additionally to the first printing unit 20 for the web-shaped material 12, a second printing unit 22 is provided for the web-shaped material 52; this is possible in all embodiments discussed in the present document. In addition, the device shown in FIG. 7 has a press-together unit 70 for pressing together the two web-shaped materials 12, 52 (or any further web-shaped materials), so that the web-shaped materials 12, 52 are supplied to the roll-up means 40 in a securely connected state; this increases the procedural safety and the quality.

Furthermore, the embodiment shown in FIG. 7 of the device 1 according to the invention has a division means 100 which can be formed for example by one or more knives or blades. This division means 100 can be used to divide the web-shaped materials 12, 52, for example in the longitudinal direction, into a plurality of parallel strips. This greatly increases the flexibility and efficiency of production.

Finally, the device 1 shown in FIG. 7 has an additional adhesive application unit 100 which can be arranged between the press-together unit 70 and the division means 100. This adhesive application unit 110 is in the present embodiment configured to apply an adhesive which remains on the surface of the web-shaped materials and is also rolled up without joining the web-shaped materials together in the roll-up means 40. On the contrary, the adhesive applied by the adhesive application unit 110 should be activated at a later point in time, for example during the attachment of the web-shaped material, which is rolled up in the roll-up means 40, to a workpiece, for example using an activation means which applies heat or the like to the adhesive.

1. A device for patterning a workpiece consisting at least partly of wood, wood materials, plastics material or the like, the device comprising:
a first web provision unit for providing a first web-shaped material effective for application to a surface of the workpiece;
a first printing unit for imprinting the first web-shaped material; and
a press-on means and/or roll-up means for pressing on and/or rolling up at least the first web-shaped material,
wherein the device further has at least a second web provision unit for providing at least a second web-shaped material in such a way that the second web-shaped material can be connected to the first web-shaped material.

2. The device according to claim 1, further comprising at least a second printing unit for imprinting the second or a further web-shaped material.

3. The device according to claim 1 or 2, further comprising a conveying means using which a relative movement between the workpiece and at least the first web provision unit can be generated.

4. The device according to claim 3, wherein at least the printing unit located at an end in a direction of conveyance of the workpieces is configured to imprint a side of the respective web-shaped material that faces the workpiece.

5. The device according to claim 4, wherein at least one printing unit is configured to imprint a side of the respective web-shaped material that faces away from the workpiece.

6. The device according to claim 5, wherein at least the web provision unit located at an end in a direction of conveyance of the workpieces provides a web-shaped material which is transparent or semitransparent at least in certain portions.

7. The device according to claim 6, wherein at least one web provision unit provides a web-shaped material which is opaque, at least in certain portions.

8. The device according to claim 1, further comprising at least one press-together unit for pressing together at least two web-shaped materials.

9. The device according to claim 1, further comprising at least one adhesive application unit and/or at least one adhesive activation unit.

10. The device according to claim 1, further comprising at least one web-shaped material to be imprinted, at least one treatment module selected from the group consisting of a precleaning module, a degreasing module, a module for improving the adhesion and wetting properties, a module for reducing the electrostatic charge and an embossing module.

11. The device according to claim 1, further comprising a division means for dividing at least one web-shaped material in the longitudinal direction thereof.

12. A method for imprinting a workpiece consisting at least partly of wood, wood materials, plastics material or the like comprising:
providing a first and at least one second web-shaped material;
imprinting at least the first web-shaped material;
joining together the first and the second web-shaped material; and
pressing onto a workpiece or rolling up the first and the second web-shaped material.

13. The method according to claim 12, wherein at least one of the web-shaped materials pressed onto the surface of the workpiece is machined in an edge region thereof.
